(19) United States
(12) Patent Application Publication
(10) Pub. No.: US 2025/0258294 A1
(43) Pub. Date: Aug. 14, 2025

(54) OBJECT DETECTION APPARATUS

(71) Applicant: Honda Motor Co., Ltd., Tokyo (JP)

(72) Inventors: Shunsuke Konishi, Saitama (JP); Daichi Saeki, Saitama (JP); Ryota Okutsu, Tokyo (JP); Hidetoshi Utsumi, Saitama (JP); Fumihiro Aoki, Saitama (JP); Shuhei Masuoka, Utsunomiya-shi (JP)

(21) Appl. No.: 19/045,476

(22) Filed: Feb. 4, 2025

(30) Foreign Application Priority Data
Feb. 9, 2024 (JP) 2024-018230

(51) Int. Cl. G01S 17/08; G01S 17/931

(52) U.S. Cl. CPC G01S 17/08; G01S 17/931

(57) ABSTRACT

An object detection apparatus includes a microprocessor configured to perform: separating point cloud data into moving point cloud data and stationary point cloud data; calculating, for each measurement point constituting the stationary point cloud data, necessary multiple required for superimposing processing based on a distance from a moving body to each measurement point to add the necessary multiple to the data; recording the stationary point cloud data to which the necessary multiple has been added; extracting a measurement point to be superimposed from the stationary point cloud data of a past frame recorded in the memory, based on the necessary multiple; performing the 10 superimposition processing to superimpose data of the measurement point to be superimposed on the stationary point cloud data of a new frame; and detecting a stationary object based on the stationary point cloud data of the new frame after the superimposing.

### CROSS-REFERENCE TO RELATED APPLICATION

This application is based upon and claims the benefit of priority from Japanese Patent Application No. 2024-018230 filed on Feb. 9, 2024, the content of which is incorporated herein by reference.

### BACKGROUND

### Technical Field

The present invention relates to an object detection apparatus configured to detect an object in the surroundings of a vehicle.

### Related Art

As this type of device, a technique for detecting an object ahead of the vehicle by using point cloud data indicating a three-dimensional position acquired by a LiDAR is known (for example, see JP 2022-57399 A).

In general, as to a distant object measured by the LiDAR, it is difficult to detect such an object, because the number of point clouds (number of measurement points) to be measured is small.

Detecting objects in the surroundings of the vehicle enables smooth movements of the vehicle, thereby leading to improvement in traffic convenience and safety. Thus, it becomes possible to contribute to development of a sustainable transportation system.

### SUMMARY

An aspect of the present invention is an object detection apparatus including: a detection unit configured to irradiate a three-dimensional space around a moving body with an electromagnetic wave and detect an exterior environment situation around the moving body based on a reflected wave; and a microprocessor and a memory coupled to the microprocessor. The microprocessor is configured to perform: acquiring point cloud data including three-dimensional position information of a measurement point on a surface of an object, from which the reflected wave is obtained, for every frame from the detection unit; separating the point cloud data into moving point cloud data corresponding to a measurement point on a surface of a moving object and stationary point cloud data other than the moving point cloud data; calculating, for every measurement point constituting the stationary point cloud data, a necessary multiple required for superimposition processing on data of each measurement point to add the necessary multiple to the data, based on a distance from the moving body to each measurement point; recording, for every frame, the stationary point cloud data including the data of each measurement point to which the necessary multiple has been added; extracting a measurement point to be superimposed from the stationary point cloud data of a past frame recorded in the memory, based on the necessary multiple; performing the superimposition processing to superimpose data of the measurement point to be superimposed on the stationary point cloud data of a new frame, when the stationary point cloud data is separated from the point cloud data of the new frame; and detecting a stationary object, based on the stationary point cloud data of the new frame after the superimposing.

### BRIEF DESCRIPTION OF DRAWINGS

The objects, features, and advantages of the present invention will become clearer from the following description of embodiments in relation to the attached drawings, in which:

FIG. 1 is a block diagram illustrating a configuration of a main part of a vehicle control device which includes an object detection apparatus;

FIG. 2 is a schematic view for describing irradiation light of a LiDAR toward a space on a forward side of a subject vehicle;

FIG. 3A is a schematic view for describing the number of measurement points scanned and irradiated on the object, which is present at the position of 50 m from the subject vehicle;

FIG. 3B is a schematic view for describing the number of measurement points scanned and irradiated on the object, which is present at the position of 100 m from the subject vehicle;

FIG. 3C is a schematic view for describing the number of measurement points scanned and irradiated on the object, which is present at the position of 150 m from the subject vehicle;

FIG. 4A is a schematic diagram illustrating measurement points in the space corresponding to the object in the first frame acquired most recently;

FIG. 4B is a schematic diagram illustrating measurement points in the space corresponding to the object in the second frame that has been acquired as a frame to be one frame before the first frame;

FIG. 4C is a schematic diagram illustrating measurement points in the space corresponding to the object in the third frame acquired as a frame to be two frames before the first frame;

FIG. 5 is a schematic diagram illustrating measurement points in the space corresponding to the object in the first frame after the superimposition;

FIG. 6A is a diagram illustrating an example of the number of measurement points for every distance that have been calculated, based on the size of the object and the irradiation angle resolution of the LiDAR 5;

FIG. 6B is a diagram illustrating an example of the necessary multiple for every distance that has been calculated, based on the number of measurement points in FIG. 6A;

FIG. 6C is a diagram illustrating a distance range for every necessary multiple that has been created, based on FIG. 6B;

FIG. 7A is a diagram for describing the stationary point cloud data of the second frame which is recorded as the past data in the memory unit;

FIG. 7B is a diagram for describing the stationary point cloud data of the third frame which is recorded as the past data in the memory unit;

FIG. 7C is a diagram for describing the stationary point cloud data of the eighth frame which is recorded as the past data in the memory unit;

FIG. 8A is a flowchart illustrating an example of object detection processing performed by a processing unit based on a predetermined program; and

FIG. 8B is a flowchart illustrating an example of object detection processing performed by the processing unit based on a predetermined program.

### DETAILED DESCRIPTION OF THE INVENTION

An object detection apparatus according to an embodiment of the invention is applicable to a vehicle having a self-driving capability, that is, a self-driving vehicle. Note that a vehicle to which the object detection apparatus according to an embodiment is applied may be referred to as a subject vehicle to be distinguished from other vehicles.

The subject vehicle may be any of an engine vehicle having an internal combustion engine (engine) as a driving power source, an electric vehicle having a driving motor as a driving power source, and a hybrid vehicle having an engine and a driving motor as a driving power source. The subject vehicle is capable of driving not only in a self-drive mode that does not require a driver's driving operation but also in a manual drive mode that requires a driver's driving operation.

While a self-driving vehicle is traveling in the self-drive mode (hereinafter, referred to as self-driving or autonomous driving), such a self-driving vehicle recognizes an exterior environment situation in the surroundings of the subject vehicle, based on detection data of an in-vehicle detection unit such as a camera or a light detection and ranging (LiDAR). The self-driving vehicle generates a driving path (a target path) after a predetermined time from the current point in time, based on a recognition result, and controls an actuator for traveling so that the subject vehicle travels along the target path.

### Vehicle Control Device

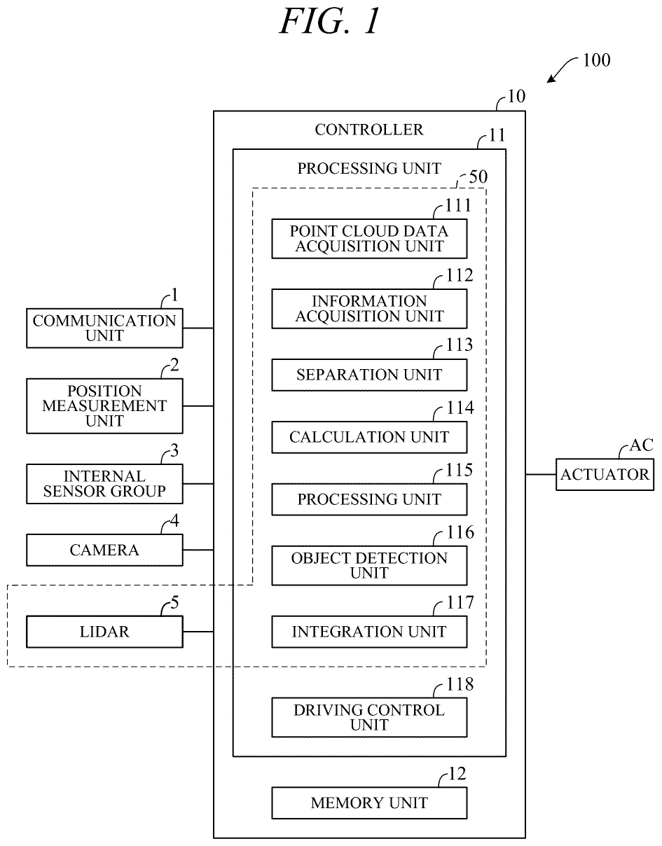

FIG. 1 is a block diagram illustrating a configuration of a main part of a vehicle control device 100, which is mounted on a subject vehicle, and which includes an object detection apparatus. The vehicle control device 100 includes a controller 10, a communication unit 1, a position measurement unit 2, an internal sensor group 3, a camera 4, a LiDAR 5, and an actuator AC for traveling. In addition, the vehicle control device 100 includes an object detection apparatus 50, which constitutes a part of the vehicle control device 100. The object detection apparatus 50 detects an object in the surroundings of a vehicle, based on detection data of the LiDAR 5.

The communication unit 1 communicates with various servers, not illustrated, through a network including a wireless communication network represented by the Internet network, a mobile telephone network, or the like, and acquires map information, traveling history information, traffic information, and the like from the servers regularly or at a given timing. The network includes not only a public wireless communication network but also a closed communication network provided for each predetermined management area, for example, a wireless LAN, Wi-Fi (registered trademark), Bluetooth (registered trademark), or the like. The acquired map information is output to a memory unit 12, and the map information recorded in the memory unit 12 is updated.

The position measurement unit (GNSS unit) 2 includes a position measurement sensor that receives a position measurement signal transmitted from a position measurement satellite. The positioning satellite is an artificial satellite such as a GPS satellite or a quasi-zenith satellite. By using the position measurement information that has been received by the position measurement sensor, the position measurement unit 2 measures a current position (latitude, longitude, and altitude) of the subject vehicle.

The internal sensor group 3 is a generic term for a plurality of sensors (internal sensors) that detect a traveling state of the subject vehicle. For example, the internal sensor group 3 includes a vehicle speed sensor that detects the vehicle speed of the subject vehicle, an acceleration sensor that detects the acceleration in a front-rear direction and the acceleration (lateral acceleration) in a left-right direction of the subject vehicle, a rotation speed sensor that detects the rotation speed of the traveling drive source, a yaw rate sensor that detects the rotation angular speed around the vertical axis of the center of gravity of the subject vehicle, and the like. The internal sensor group 3 also includes a sensor that detects a driver's driving operation in the manual drive mode, for example, an operation on an accelerator pedal, an operation on a brake pedal, or an operation on a steering wheel.

The camera 4 includes an imaging element such as a CCD or a CMOS, and captures images of the surroundings (forward, rearward, and sideward sides) of the subject vehicle.

The LiDAR 5 irradiates a three-dimensional space in the surroundings of the subject vehicle with an electromagnetic wave (laser light or the like), and detects an exterior environment situation in the surroundings of the subject vehicle, based on the reflected wave from an object. More specifically, the laser light or the like irradiated by the LiDAR 5 is reflected at a certain point (may be referred to as a measurement point) on the surface of an object, and returns to the LiDAR 5. Therefore, in a case of the LiDAR 5 of a frequency continuous modulation (FMCW) method, the distance from the light source of the LiDAR 5 to such a certain point, the intensity of the laser light or the like that has been reflected and returned, the relative speed of the object located at such a measurement point, and the like are measured. In addition, in a case of the LiDAR 5 of the time of flight (ToF) method, the distance from the light source of the LiDAR 5 to the point and the intensity of the laser light or the like that has been reflected and returned are measured. In carrying out the present invention, either the FMCW method or the ToF method may be adopted as the LiDAR 5. That is, the laser light or the like by the LiDAR 5, which is attached to a predetermined position (front portion) of the subject vehicle, is scanned and irradiated in the horizontal direction and the vertical direction with respect to the surroundings (front portion) of the subject vehicle. Thus, it is sufficient if it is possible to detect at least the position and the shape of an object (a moving object such as another vehicle and a stationary object such as a road surface or a structure) on a forward side of the subject vehicle. A target object detected by the LiDAR 5 will be referred to as an object including a person. Therefore, the moving object includes a moving person (a pedestrian or the like) in addition to a vehicle such as a moving automobile or bicycle, and the stationary object includes a person standing still on a road, a fallen object, and the like in addition to a structure of a road and a parked vehicle.

Note that in the following description, the above three-dimensional space is represented by an X axis along an advancing direction (may also be referred to as a depth direction) of the subject vehicle, a Y axis along a vehicle width direction (corresponding to the horizontal direction) of the subject vehicle, and a Z axis along a height direction (corresponding to the vertical direction) of the subject vehicle. Therefore, the above three-dimensional space may be referred to as an XYZ space.

The actuator AC is an actuator for traveling so as to control traveling of the subject vehicle. In a case where the traveling drive source is an engine, the actuators AC includes a throttle actuator that adjusts an opening of a throttle valve (throttle opening) of the engine. In a case where the traveling drive source is a traveling motor, the actuators AC includes the traveling motor. The actuator AC also includes a brake actuator that operates a braking device of the subject vehicle and a steering actuator that drives the steering device.

The controller 10 includes an electronic control unit (ECU). More specifically, the controller 10 includes a computer including a processing unit 11 such as a CPU (microprocessor), a memory unit 12 such as a ROM and a RAM, and other peripheral circuits, not illustrated, such as an I/O interface.

Note that a plurality of ECUs having different functions such as an engine control ECU, a traveling motor control ECU, and a braking device ECU can be separately provided, but in FIG. 1, the controller 10 is illustrated as an aggregation of these ECUs as a matter of convenience.

The memory unit 12 records highly precise detailed map information (referred to as high-precision map information). The high-precision map information includes information of positions of roads, information of road shapes (curvatures or the like), information of gradients of roads, position information of intersections and branch points, information of the number of traffic lanes (driving lanes), widths of traffic lanes and position information of every traffic lane (information of center positions of traffic lanes and boundary lines between traffic lane positions), position information of landmarks (traffic lights, traffic signs, buildings, and the like) as marks on a map, and information of road surface profiles such as irregularities of road surfaces.

In addition, the memory unit 12 records programs for various types of control, information such as threshold values for use in the programs, and setting information for the in-vehicle detection unit such as the LiDAR 5.

Furthermore, the memory unit 12 is also capable of recording data that has been acquired by the LiDAR 5, as past data.

### Configuration of Processing Unit

The processing unit 11 includes, as functional configurations, a point cloud data acquisition unit 111, an information acquisition unit 112, a separation unit 113, a calculation unit 114, a processing unit 115, an object detection unit 116 (hereinafter, simply referred to as the detection unit), an integration unit 117, and a driving control unit 118.

Note that as illustrated in FIG. 1, the point cloud data acquisition unit 111, the information acquisition unit 112, the separation unit 113, the calculation unit 114, the processing unit 115, the detection unit 116, and the integration unit 117 are included in the object detection apparatus 50. Details of each unit included in the object detection apparatus 50 will be described later.

In the self-drive mode, the driving control unit 118 generates a target path, based on an exterior environment situation in the surroundings of the vehicle, including a size, a position, a relative moving speed, and the like of an object that has been detected by the object detection apparatus 50. Specifically, the driving control unit 118 generates the target path to avoid collision or contact with the object or to follow the object, based on the size, the position, the relative moving speed, and the like of the object that has been detected by the object detection apparatus 50. The driving control unit 118 controls the actuator AC so that the subject vehicle travels along the target path. Specifically, the driving control unit 118 controls the actuator AC along the target path to adjust an accelerator opening or to actuate a braking device or a steering device. Note that in the manual drive mode, the driving control unit 118 controls the actuator AC in accordance with a traveling command (a steering operation or the like) from the driver that has been acquired by the internal sensor group 3.

### Irradiation Light by LiDAR

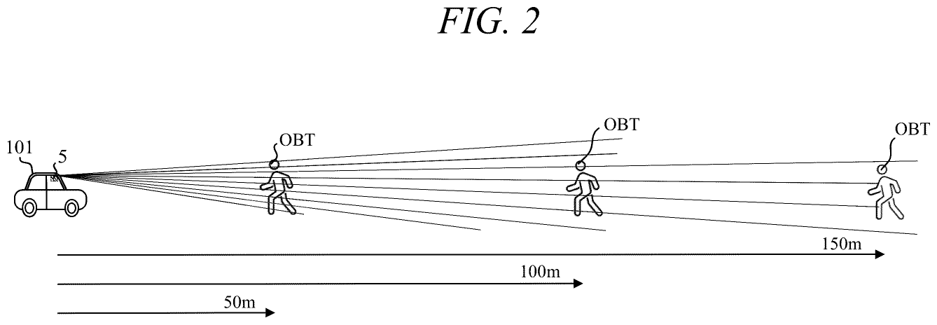

FIG. 2 is a schematic view for describing irradiation light of the LiDAR 5 toward a space on a forward side of a subject vehicle 101. In an embodiment, laser light or the like is sequentially scanned and irradiated on a plurality of measurement points set beforehand in the field of view (hereinafter, referred to as FOV) of the LiDAR 5, and detection data based on a reflected wave from each measurement point is acquired. Information based on reflected waves from the plurality of measurement points in the FOV will be referred to as detection data for one frame. The LiDAR 5 repeats irradiating the plurality of measurement points in the FOV with laser light or the like and receiving the reflected waves from the plurality of measurement points in the unit of frame.

As illustrated in FIG. 2, in a case where an identical object OBT is present at different distances from the subject vehicle 101, the number of measurement points on the object surface of the object OBT increases, as the distance to the object OBT is shorter, and the number of measurement points on the object surface decreases, as the distance to the object OBT is longer.

In the example of FIG. 2, the number of measurement points scanned and irradiated on the object OBT, which is present at the position of 100 m from the subject vehicle 101, is smaller than the number of measurement points scanned and irradiated on the object OBT, which is present at the position of 50 m from the subject vehicle 101. In addition, the number of measurement points scanned and irradiated on the object OBT, which is present at the position of 150 m from the subject vehicle 101, is smaller than the number of measurement points scanned and irradiated on the object OBT, which is present at the position of 100 m from the subject vehicle 101.

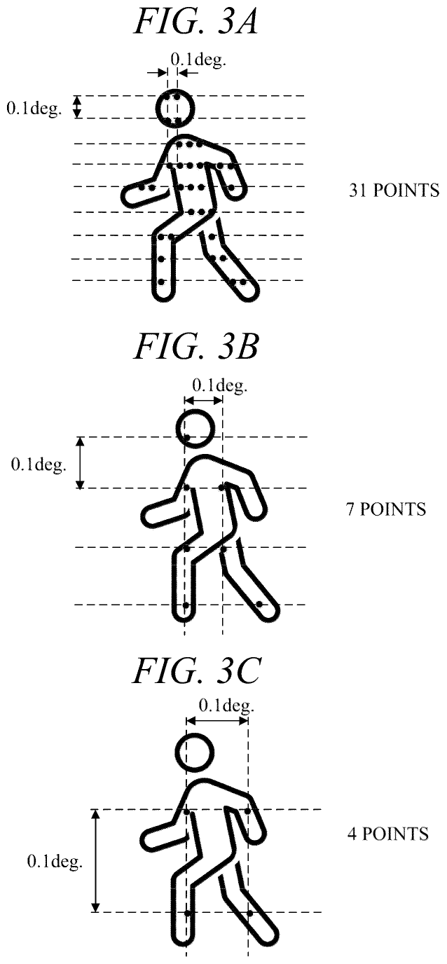

FIGS. 3A, 3B, and 3C are schematic diagrams illustrating the number of measurement points scanned and irradiated on the object OBT, which is present at the respective positions of 50 m, 100 m, and 150 m from the subject vehicle 101 in FIG. 2. In an embodiment, as an example, it is assumed that the irradiation direction of the laser light or the like is controlled to scan at 0.1 deg intervals in both the vertical direction and the horizontal direction, and the size of the object OBT to be detected is 0.3 m in the horizontal direction and 0.8 m in the vertical direction. That is, the numbers of measurement points illustrated in FIGS. 3A, 3B, and 3C respectively indicate that the numbers of measurement points in the space (0.3 m×0.8 m in the present example) corresponding to the object OBT, which is present at positions of 50 m, 100 m, and 150 m from the subject vehicle 101, are 31 points, 7 points, and 4 points.

In order to detect a certain object OBT, the object detection apparatus 50 counts the number of a plurality of measurement points (the number of measurement points that constitute a group) that are substantially equal in value of the distance to the measurement point, value of XYZ coordinates of the measurement point, value of a relative speed of the measurement point, or absolute speed value of the measurement point in the detection data of the frame acquired most recently (referred to as a first frame for convenience), based on a policy of ensuring at least a predetermined number of measurement points (for example, 10 points) or more on the object surface. Being substantially equal in value means that values are approximated to an extent to be considered as the measurement points on an identical object surface.

Subsequently, the size of the object to be measured (here, 0.3 m×0.8 m) and the maximum detection distance (for example, 150 m) are defined, and the data of the measurement points are selectively superimposed in anticipation of increasing the number of measurement points that constitute the group up to the above predetermined number (here, 10) at any distance up to the maximum detection distance. Specifically, from among the data of the measurement points of the past frames that have been acquired before the first frame (referred to as a second frame, a third frame, and so on, for convenience), the measurement points that should be kept are determined and extracted to correspond to in which past frame such a measurement point is included and the distance to such a measurement point. Then, the extracted data of the measurement points of the past frame is superimposed on the detection data of the first frame. For the data of the measurement point of the past frame, the data recorded as the past data in the above-described memory unit 12 is used.

The schematic diagram illustrated in FIG. 3A illustrates a case where the object OBT is present at the position of 50 m from the subject vehicle 101. The number of measurement points in the space corresponding to the object OBT is 31 points, and the predetermined number (here, 10) or more is ensured, and thus this is an example where data superimposition of the measurement points is unnecessary.

The schematic diagram illustrated in FIG. 3B illustrates a case where the object OBT is present at the position of 100 m from the subject vehicle 101. The number of measurement points in the space corresponding to the object OBT is 7 points, and the predetermined number (here, 10) or more is not ensured, and thus this is an example where the data superimposition of the measurement points is necessary.

The schematic diagram illustrated in FIG. 3C illustrates a case where the object OBT (FIG. 3C) is present at the position of 150 m from the subject vehicle 101. The number of measurement points in the space corresponding to the object OBT is 4 points, and similarly to FIG. 3B, the predetermined number (here, 10) or more is not ensured, and thus this is an example where the data superimposition of the measurement points is necessary.

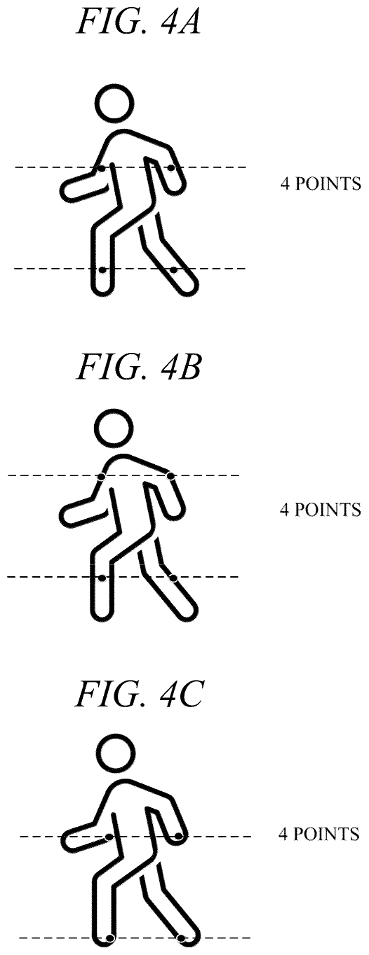

Referring to FIGS. 4A, 4B, and 4C, description will be given with regard to an example of superimposing the data of the measurement points in the space corresponding to the object OBT, which is present at the position of 150 m from the subject vehicle 101. FIG. 4A is a schematic diagram illustrating measurement points (4 points) in the space corresponding to the object OBT in the above first frame acquired most recently, and is similar to the case of FIG. 3C.

FIG. 4B is a schematic diagram illustrating measurement points (4 points) in the space corresponding to the object OBT in the second frame that has been acquired as a frame to be one frame before the first frame.

FIG. 4C is a schematic diagram illustrating measurement points (4 points) in the space corresponding to the object OBT in a past frame (the third frame) acquired as a frame to be two frames before the first frame.

The object detection apparatus 50 superimposes the data of corresponding measurement points (4 points) in the second frame, which is the frame to be one frame before the first frame (FIG. 4B), on the data of the measurement point (4 points) in the first frame illustrated in FIG. 4A for every measurement point. In the first frame after the superimposition, the number of measurement points in the space corresponding to the object OBT increases to 8 points (4+4=8). However, the number has not yet increased to reach the above predetermined number (here, 10) or more. Subsequently, the object detection apparatus 50 superimposes the data of corresponding measurement points (4 points) in the third frame, which is the frame to be further one frame before (FIG. 4C), on the data of measurement points (8 points) in the space corresponding to the object OBT in the first frame after the superimposition for every measurement point.

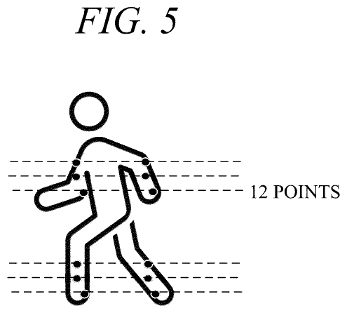

FIG. 5 is a schematic diagram illustrating measurement points (12 points) in the space corresponding to the object OBT in the first frame after the superimposition. In FIG. 5, the number of measurement points in the space corresponding to the object OBT has increased to 12 points (8+4=12), and the predetermined number (here, 10) or more is ensured.

The object detection apparatus 50 sequentially superimposes the data of the measurement points of the frame in the past in anticipation of increasing the number of measurement points in the space corresponding to the object OBT to the predetermined number (here, 10), and then detects the presence of the object OBT based on stationary point cloud data.

Such an object detection apparatus 50 will be described in more detail.

### Details of Object detection apparatus

The object detection apparatus 50 includes the LiDAR 5, in addition to the point cloud data acquisition unit 111, the information acquisition unit 112, the separation unit 113, the calculation unit 114, the processing unit 115, the detection unit 116, and the integration unit 117, which have been described above.

The point cloud data acquisition unit 111 acquires the point cloud data including position information indicating three-dimensional position coordinates of a measurement point on the surface of the object OBT obtained by the LiDAR 5 and speed information indicating a relative moving speed of the measurement point, as the detection data of the LiDAR 5. The point cloud data acquisition unit 111 acquires the point cloud data in units of frames at predetermined time intervals. The predetermined time corresponds to a period of time while the LiDAR 5 scans and irradiates the plurality of measurement points set in the FOV of the LiDAR 5 with the laser light or the like at the above-described 0.1 deg intervals, and then the LiDAR 5 outputs detection data for one frame based on the reflected wave from each measurement point in the FOV. The number of frames of the point cloud data acquired per second by the point cloud data acquisition unit 111 may be referred to as a frame rate of the point cloud data.

The information acquisition unit 112 acquires necessary multiple information indicating a relationship between the distance to the measurement point on the surface of the object OBT to be detected by the LiDAR 5 and the number that necessitates the superimposition of the data of the measurement point (hereinafter, referred to as a necessary multiple).

The necessary multiple information acquired by the information acquisition unit 112 is information that has been calculated as follows. First, the number of measurement points (FIGS. 3A, 3B and 3C) in the space (0.3 m×0.8 m in the present example) corresponding to the object OBT is calculated for every distance from the subject vehicle 101, based on a predetermined size of the object OBT as the detection target and an irradiation angle resolution (for example, at the above 0.1 deg intervals) of the laser light or the like scanned and irradiated from the LiDAR 5. Subsequently, the number of frames required for the superimposition for ensuring a predetermined number (here, 10) or more of the measurement points in the space corresponding to the object OBT at each distance is calculated as the above necessary multiple of the data of the measurement point.

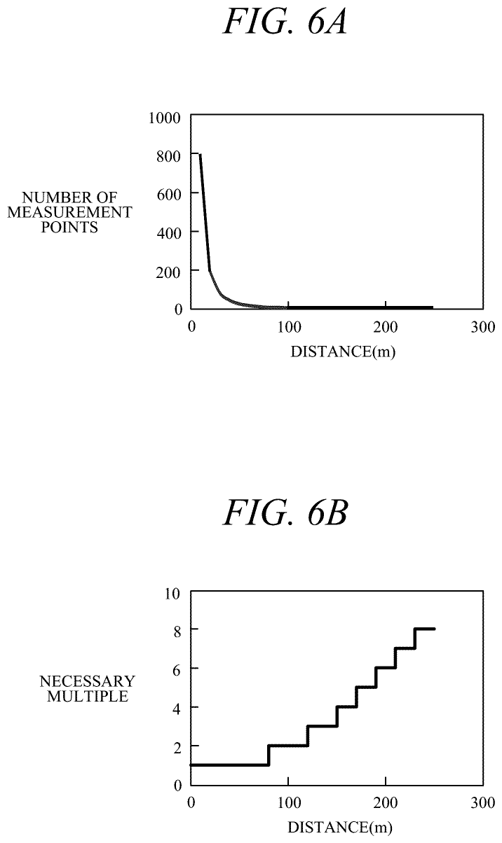

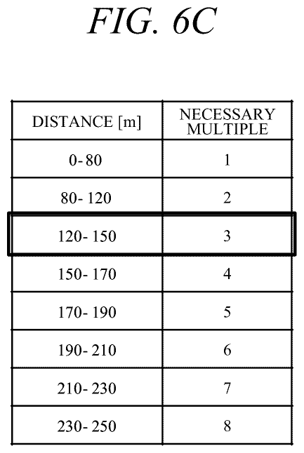

FIG. 6A is a diagram illustrating an example of the number of measurement points for every distance that have been calculated, based on the size of the object OBT and the irradiation angle resolution of the LiDAR 5. The horizontal axis indicates the distance to the space corresponding to the object OBT, and the vertical axis indicates the number of measurement points. In the graph of FIG. 6A, the number of measurement points in the space corresponding to the object OBT to be detected by the LiDAR 5 is indicated for every distance from the subject vehicle 101.

FIG. 6B is a diagram illustrating an example of the necessary multiple for every distance that has been calculated, based on the number of measurement points in FIG. 6A. The horizontal axis indicates the distance to the space corresponding to the object OBT, and the vertical axis indicates the necessary multiple. In the graph of FIG. 6B, the necessary multiple of the data of the measurement points required for ensuring a predetermined number (here, 10) or more of the measurement points in the space corresponding to the object OBT is indicated for every distance from the subject vehicle 101. A case where the necessary multiple is 1 indicates that the superimposition using the data of the measurement points of the past frame is unnecessary (in other words, the number of frames required for the superimposition is 0), and a case where the necessary multiples are 2, 3, . . . 7, and 8 indicates that the numbers of frames required for the superimposition using the data of the measurement points of the past frame are respectively 1, 2, . . . 6, and 7.

FIG. 6C is a diagram illustrating a distance range for every necessary multiple that has been created, based on FIG. 6B. As an example, in focusing on a case where the distance from the subject vehicle 101 to the space corresponding to the object OBT is 150 m, the fact that the necessary multiple is theoretically 3 is indicated.

The information acquired by the information acquisition unit 112 is the necessary multiple information corresponding to FIG. 6C. In a case where the necessary multiple number information is recorded beforehand in a predetermined area of the memory unit 12, the information acquisition unit 112 reads and acquires the necessary multiple number information from the memory unit 12. In addition, the information acquisition unit 112 may receive the above information from an external device via the communication unit 1.

The separation unit 113 separates the point cloud data that has been acquired by the point cloud data acquisition unit 111 into moving point cloud data corresponding to the measurement points on the surface of the moving object and stationary point cloud data (point cloud data having a sufficiently small moving speed) other than the moving point cloud data. The reason for the separation is to apply the above-described superimposition processing using the data of the measurement points of the past frame to only the stationary point cloud data. More specifically, the position of the moving object is different in every frame of the point cloud data. Hence, even if the superimposition processing using the data of the measurement points of the past frame is applied to the moving point cloud data, there is a possibility that it is not possible to sufficiently increase the number of measurement points in the space corresponding to the object OBT by the superimposition processing. In addition, a measurement point that is not actually present is generated near the space corresponding to the object OBT. Hence, there is a possibility that an object is detected at a position where the object is not actually present. On the other hand, the position of the stationary object is substantially coincident in each frame of the point cloud data (the degree of slightly deviating due to swinging or the like of the subject vehicle 101). Therefore, by applying the superimposition processing using the data of the measurement points of the past frame to the stationary point cloud data, it becomes possible to anticipate an increase in the number of measurement points in appearance in the space corresponding to the object OBT by the superimposition processing.

When the separation unit 113 separates the stationary point cloud data of a new frame, the calculation unit 114 calculates and adds the necessary multiple to the data of each measurement point, based on the necessary multiple number information (FIG. 6C) that has been acquired by the information acquisition unit 112 using the distance from the subject vehicle 101 to the measurement point. The point cloud data including the data of the measurement point to which the necessary multiple has been added is recorded in the memory unit 12, as the point cloud data of the first frame.

In addition, the calculation unit 114 extracts the measurement point required for the superimposition from the point cloud data of the second frame, based on the value of the necessary multiple of each measurement point that constitutes the point cloud data of the second frame recorded in the memory unit 12, as a past frame to be one frame before the first frame (the past frame ID is set to 1), and the value of the past frame ID.

More specifically, the calculation unit 114 determines, as a measurement point for use in the superimposition, a measurement point having a larger number (in this case, a number larger than 2) of the necessary multiple of each measurement point that constitutes the point cloud data of the second frame than the past frame ID, and keeps the data of such a measurement point in the memory unit 12. That is, the data of the measurement point, the necessary multiple of which is identical to the frame ID or the necessary multiple of which is smaller than the value of the frame ID, is deleted from the memory unit 12, as data not required for the superimposition.

Similarly, also for the point cloud data of the third frame recorded in the memory unit 12, as the past frame (the past frame ID is set to 2) to be two frames before the first frame, the necessity determination of whether to keep the data as the measurement point for use in the superimposition in the memory unit 12 is made, based on the necessary multiple and the past frame ID (in this case, 2), and the data of the measurement point not required for the superimposition is deleted from the memory unit 12.

Similar processing as described above is repeated until the number for the superimposition reaches the maximum necessary multiple (in this case, 8) in FIG. 6C. In other words, the processing is repeatedly performed up to the seventh frame recorded in the memory unit 12, as the past frame to be seven frames before the first frame (the past frame ID is set to 7).

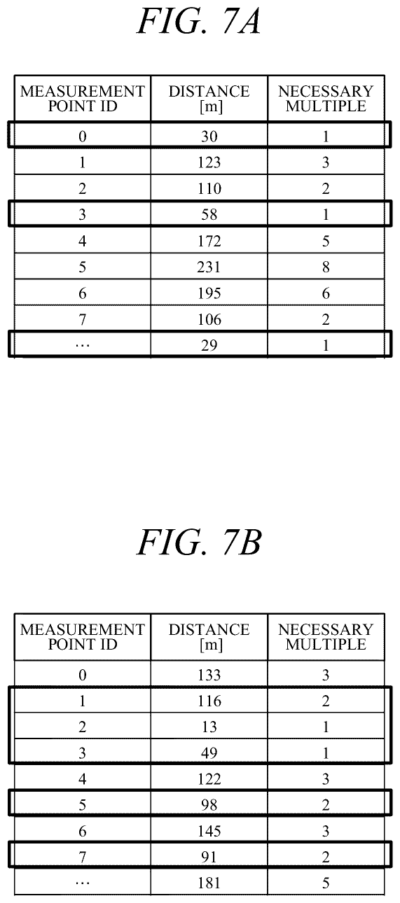

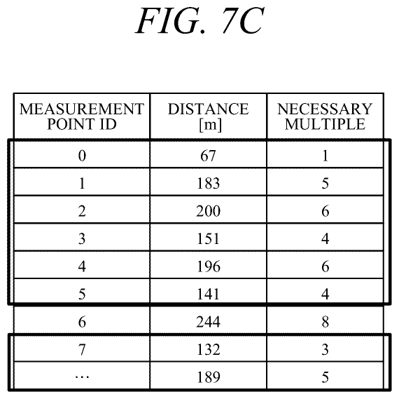

The above processing of extracting the measurement point for use in the superimposition from the point cloud data of the past frame will be described in detail with reference to FIGS. 7A, 7B, and 7C. FIGS. 7A, 7B, and 7C are diagrams each illustrating the stationary point cloud data of the past frame recorded in the memory unit 12, when the stationary point cloud data of the first frame that is the most recent one is separated.

FIG. 7A is a diagram for describing the stationary point cloud data of the second frame (the past frame ID is 1), in which the acquisition, the separation, and the calculation of the necessary multiple are completed in the frame located one frame before the first frame, and which is recorded as the past data in the memory unit 12.

FIG. 7B is a diagram for describing the stationary point cloud data of the third frame (the past frame ID is 2), in which the acquisition, the separation, and the calculation of the necessary multiple are completed in the frame located two frames before the first frame, and which is recorded as the past data in the memory unit 12.

FIG. 7C is a diagram for describing the stationary point cloud data of an eighth frame (the past frame ID is 7), in which the acquisition, the separation, and the calculation of the necessary multiple are completed in the frame located seven frames before the first frame (in other words, the frame located six frames before the second frame), and which is recorded as the past data in the memory unit 12.

In FIG. 7A (in the stationary point cloud data of the frame located one frame before the first frame, that is, the frame having the past frame ID of 1), data of a measurement point having the necessary multiple that is identical to or smaller than the past frame ID (here, 1) is surrounded by a thick frame. The region surrounded by the thick frame is the data of the measurement point for which the superimposition using the data of the measurement point of the past frame is unnecessary. That is, the data may be deleted from the memory unit 12 (or excluded from the superimposition).

In FIG. 7B (in the stationary point cloud data of the frame to be two frames before the first frame, that is, the frame having the past frame ID of 2), data of a measurement point having the necessary multiple that is identical to or smaller than the past frame ID (here, 2) is surrounded by a thick frame. The region surrounded by the thick frame is the data of the measurement point for which the superimposition using the data of the measurement point of the past frame is unnecessary. That is, the data may be deleted from the memory unit 12 (or excluded from the superimposition).

In FIG. 7C (in the stationary point cloud data of the frame to be seven frames before the first frame, that is, the frame having the past frame ID of 7), data of a measurement point having the necessary multiple that is identical to or smaller than the past frame ID (here, 7) is surrounded by a thick frame. The region surrounded by the thick frame is the data of the measurement point for which the superimposition using the data of the measurement point of the past frame is unnecessary. That is, the data may be deleted from the memory unit 12 (or excluded from the superimposition).

As described above, by extracting the measurement points for use in the superimposition from the point cloud data of the past frame and keeping only the data of the extracted measurement points as the stationary point cloud data of the past frame in the memory unit 12, it becomes possible to suppress the capacity to be secured for the stationary point cloud data of the past frame in the memory capacity of the memory unit 12, as compared with the case of keeping the data of all the measurement points as the stationary point cloud data of the past frame.

The processing unit 115 superimposes the data of the corresponding measurement point (in other words, the extracted measurement point) in the stationary point cloud data of the past frame (the above second frame, the above third frame, and so one), which is acquired and separated before the first frame and recorded in the memory unit 12, on the data of each measurement point that constitutes the stationary point cloud data of the first frame to which the necessary multiple of every measurement point has been added by the calculation unit 114.

The detection unit 116 detects an object in each of the stationary point cloud data and the moving point cloud data.

### Stationary Point Cloud Data

The maximum size (Xmax and Ymax) in an XY direction of the object OBT is recognizable without information in a height direction (Z direction) of the object OBT. Therefore, the detection unit 116 projects each measurement point that constitutes the stationary point cloud data on an XY plane so as to remove the information in the height direction from the position information of each measurement point corresponding to the stationary point cloud data, and converts the position information of each measurement point from three dimensions to two dimensions. Specifically, in a case where the position coordinates of each measurement point are represented in an XYZ coordinate system, the detection unit 116 projects each measurement point corresponding to the stationary point cloud data on the XY plane, and converts the stationary point cloud data into two-dimensional data represented in an XY coordinate system.

The detection unit 116 detects a stationary object in the surroundings of the subject vehicle 101, based on the converted XY data. As an example, clustering processing is performed on the two-dimensional data on the XY plane to detect a bounding box that is a circumscribed region of the stationary object from the XY plane. Information indicating a detection result of the stationary object is recorded in the memory unit 12, for example.

As another example of detecting a stationary object in the surroundings of the subject vehicle 101, the following method may be adopted. That is, the detection unit 116 divides the XY plane into a lattice shape of a grid having a predetermined size, and extracts only a differential value between a maximum value and a minimum value in the height direction of each measurement point of the stationary point cloud data present in each grid. Then, only the grid, the differential value of which exceeds a predetermined threshold, is detected as a three-dimensional object.

### Moving Point Cloud Data

Similarly to the case of the stationary point cloud data, the detection unit 116 detects a moving object for the moving point cloud data. Information indicating a detection result of the moving object is recorded in the memory unit 12, for example.

The integration unit 117 integrates object information derived from the stationary point cloud that has been detected by the detection unit 116 with object information derived from the moving point cloud that has been detected by the detection unit 116 on a two-dimensional coordinate map on the XY plane. Information indicating an integration result is recorded in the memory unit 12, for example.

### Description of Flowchart

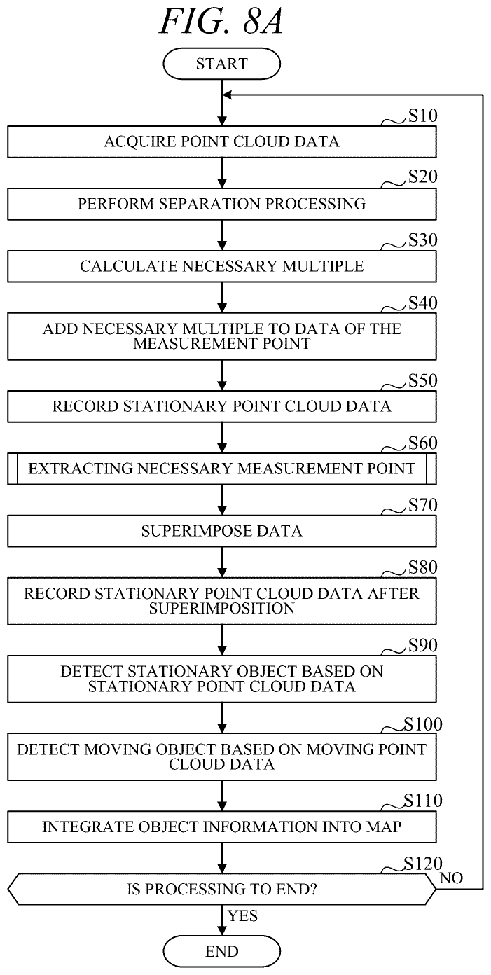

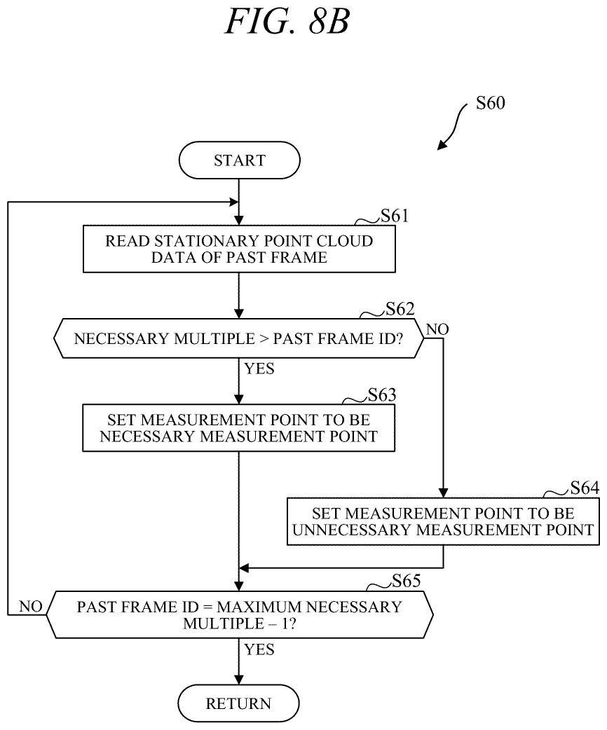

FIGS. 8A and 8B are flowcharts illustrating an example of object detection processing performed by the processing unit 11 of the controller 10 in FIG. 1, based on a predetermined program. The processing illustrated in the flowcharts of FIGS. 8A and 8B is repeatedly performed at predetermined intervals while the subject vehicle 101 is traveling in the self-drive mode, for example.

First, in step S10 of FIG. 8A, the processing unit 11 causes the point cloud data acquisition unit 111 to acquire three-dimensional point cloud data from the LiDAR 5, and the processing proceeds to step S20.

In step S20, the processing unit 11 causes the separation unit 113 to perform separation processing of separating the point cloud data that has been acquired by the point cloud data acquisition unit 111 into the moving point cloud data corresponding to the measurement point on the surface of the moving object and the stationary point cloud data other than the moving point cloud data, and the processing proceeds to step S30.

An example of the separation processing will be described. The separation unit 113 estimates an absolute moving speed of the subject vehicle 101, based on the position information indicating the three-dimensional position coordinates of the measurement point on the surface of the object OBT included in the point cloud data that has been acquired by the LiDAR 5 and the speed information indicating a relative moving speed of the measurement point.

First, point cloud data obtained by removing the information of the measurement point corresponding to the object OBT from the point cloud data, that is, point cloud data corresponding to the road surface (hereinafter, referred to as road surface point cloud data) in the surroundings of the subject vehicle 101 is extracted. A unit vector indicating the direction of the relative moving speed is calculated, based on the position coordinates (three-dimensional position) included in the road surface point cloud data that has been extracted.

Next, a conversion equation for converting the relative moving speed of the measurement point corresponding to the road surface into the absolute moving speed is set as an objective function, and by solving an optimization problem for optimizing the objective function to approach 0, the moving speed (absolute moving speed) of the subject vehicle 101 is estimated.

Furthermore, the absolute moving speed of each of the plurality of measurement points corresponding to the point cloud data is calculated, based on the relative moving speed of the measurement point and the absolute moving speed of the subject vehicle 101 that has been estimated.

Finally, the point cloud data is divided into the moving point cloud data corresponding to the measurement point at which the absolute value of the absolute moving speed is equal to or higher than a predetermined speed and the stationary point cloud data other than the moving point cloud data.

In step S30, the processing unit 11 causes the calculation unit 114 to calculate a necessary multiple for every measurement point for the stationary point cloud data after the separation, and the processing proceeds to step S40.

In step S40, the processing unit 11 causes the calculation unit 114 to add the necessary multiple to the data of the measurement point, and the processing proceeds to step S50.

In step S50, the processing unit 11 records, in the memory unit 12, the stationary point cloud data of the first frame to which the necessary multiple has been added, and the processing proceeds to step S60. By the processing in steps S10 to S50, whenever the point cloud data of a new frame is acquired, the stationary point cloud data in which the separation, the calculation of the necessary multiple, and the addition of the necessary multiple are completed are repeatedly recorded. Upon acquisition of the point cloud data of a new frame, the stationary point cloud data recorded in the memory unit 12 at such a timing becomes the stationary point cloud data of a past frame.

In step S60, the processing unit 11 causes the calculation unit 114 to perform processing of extracting a measurement point required for the superimposition from the point cloud data of the past frame, based on the value of the necessary multiple of each measurement point that constitutes the point cloud data recorded as the past frame in the memory unit 12 and the value of the past frame ID, and the processing proceeds to step S70. Details of the processing in step S60 will be described later with reference to FIG. 8B

In step S70, the processing unit 11 causes the processing unit 115 to superimpose data of a corresponding measurement point in the stationary point cloud data of the past frames (the second frame, the third frame, and so on), which have been acquired and separated before the first frame and recorded in the memory unit 12, on the data of each measurement point that constitutes the stationary point cloud data of the first frame, and the processing proceeds to step S80.

In step S80, the processing unit 11 records the stationary point cloud data of the frame after the superimposition in the memory unit 12, and the processing proceeds to step S90.

In step S90, the processing unit 11 causes the detection unit 116 to detect a stationary object in the surroundings of the subject vehicle 101, based on the stationary point cloud data after the superimposition, and the processing proceeds to step $100.

In step S100, the processing unit 11 causes the detection unit 116 to detect a moving object in the surroundings of the subject vehicle 101, based on the moving point cloud data, and the processing proceeds to step S110.

In step S110, the processing unit 11 causes the integration unit 117 to integrate the object information derived from the stationary point cloud that has been detected by the detection unit 116 with the object information derived from the moving point cloud that has been detected by the detection unit 116, on a two-dimensional coordinate map on the XY plane, and the processing proceeds to step S120.

In step S120, the processing unit 11 determines whether to end the processing. While the subject vehicle 101 is continuously traveling in the self-drive mode, the processing unit 11 makes a negative determination in step S120, returns to step S10 in FIG. 8A, and repeats the above-described processing. By returning to step S10, the detection of an object or the like based on the point cloud data is periodically and repeatedly performed, while the subject vehicle 101 is traveling. On the other hand, when the subject vehicle 101 ends traveling in the self-drive mode, the processing unit 11 makes an affirmative determination in step S120, and ends the processing of FIG. 8A.

FIG. 8B is a flowchart for describing details of the processing of step S60 (FIG. 8A) performed by the processing unit 11.

In step S61, the processing unit 11 causes the calculation unit 114 to read the stationary point cloud data of the past frame from the memory unit 12, and the processing proceeds to step S62. The initial value of the past frame ID of the past frame to be read is 1.

In step S62, the processing unit 11 causes the calculation unit 114 to determine whether “necessary multiple>past frame ID” is satisfied for every measurement point of the stationary point cloud data of the past frame that has been read. In a case where “necessary multiple>past frame ID” is satisfied, the calculation unit 114 makes an affirmative determination in step S62, and the processing proceeds to step S63 to set the measurement point to be the measurement point required for the superimposition.

On the other hand, in a case where “necessary multiple>past frame ID” is not satisfied, the calculation unit 114 makes a negative determination in step S62, and the processing proceeds to step S64 to set the measurement point to be the measurement point not required for the superimposition.

In step S65, the processing unit 11 causes the calculation unit 114 to determine whether “past frame ID=maximum necessary multiple−1” is satisfied. In a case where it is satisfied, the calculation unit 114 makes an affirmative determination in step S65, ends the processing of FIG. 8B, and returns to FIG. 8A, and the processing proceeds to step S70. In a case where it is not satisfied, the calculation unit 114 makes a negative determination in step S65, changes the past frame ID to increase its value by one, and returns to step S61 in FIG. 8B.

Through the processing that has been described heretofore, the processing is repeatedly performed until the value of the past frame ID becomes the maximum necessary multiple−1.

According to the embodiment described above, the following effects are obtained.

(1) The object detection apparatus 50 includes: the LiDAR 5, which is mounted on the subject vehicle 101 as a moving body, and which serves as a detection unit that irradiates a three-dimensional space in the surroundings of the subject vehicle 101 with laser light or the like as an electromagnetic wave and that detects an exterior environment situation in the surroundings of the subject vehicle 101 based on a reflected wave; the point cloud data acquisition unit 111, which acquires point cloud data including three-dimensional position information of a measurement point on a surface of the object OBT, from which the reflected wave is obtained for every frame from the LiDAR 5; the separation unit 113, which separates the point cloud data that has been acquired by the point cloud data acquisition unit 111 into moving point cloud data corresponding to the measurement point on the surface of the moving object OBT and stationary point cloud data other than the moving point cloud data; the calculation unit 114, which calculates a necessary multiple required for superimposition processing on data of each measurement point, and which adds the necessary multiple to the data for every measurement point that constitutes the stationary point cloud data that has been separated by the separation unit 113, based on a distance from the subject vehicle 101 to each measurement point; the memory unit 12, which records, for every frame, the stationary point cloud data including the data of each measurement point to which the necessary multiple has been added; the processing unit 115, which serves as a data processing unit that performs the superimposition processing to superimpose data of a measurement point to be superimposed extracted, based on the necessary multiple, from the stationary point cloud data of a past frame recorded in the memory unit 12 on stationary point cloud data of a new frame, when the stationary point cloud data of the new frame is separated by the separation unit 113; and the detection unit 116, which detects a stationary object, based on the stationary point cloud data of the new frame after the superimposition processing by the processing unit 115.

With such a configuration, it becomes possible to appropriately detect the stationary object having a small number of measurement points on the object surface because it is present in a distant place or it has a small size even though it is present in the vicinity of the subject vehicle 101.

The moving point cloud data that can be erroneous data by the superimposition processing is separated, and the superimposition processing is performed only on the data of the measurement point that constitutes the stationary point cloud data, so that an appropriate superimposition effect can be obtained.

(2) The object detection apparatus 50 further includes the information acquisition unit 112, which acquires necessary multiple information in which a relationship between the distance from the subject vehicle 101 to the measurement point and the necessary multiple has been determined beforehand, and the calculation unit 114 calculates the necessary multiple for every measurement point that constitutes the stationary point cloud data that has been separated by the separation unit 113, based on the distance from the subject vehicle 101 to each measurement point and the necessary multiple information that has been acquired by the information acquisition unit 112.

With such a configuration, it becomes possible to appropriately calculate the necessary multiple required for the superimposition processing.

(3) In the object detection apparatus 50, the calculation unit 114 extracts the measurement point to be superimposed from measurement points constituting the stationary point cloud data of multiple past frames recorded in the memory unit 12, based on which past frame each of the measurement points belongs to relative to a current frame and the distance from the subject vehicle 101 to each of the measurement points.

With such a configuration, it becomes possible to appropriately superimpose the data of the corresponding measurement point in the stationary point cloud data of the past frame (for example, the second frame, the third frame, and so on) recorded in the memory unit 12 on the data of each measurement point that constitutes the stationary point cloud data of the first frame that is the new frame.

That is, as compared with a case where the data of all the measurement points that constitute the stationary point cloud data of the past frame is superimposed, it becomes possible to suppress and reduce the load of the processing and suppress and reduce the capacity of the memory for use in the processing.

(4) In the object detection apparatus 50, the calculation unit 114 removes data that has not been extracted in the above (3) from the stationary point cloud data of the past frame recorded in the memory unit 12.

With such a configuration, it becomes possible to suppress and reduce the memory capacity of the memory unit 12, as compared with a case where the data not required for the superimposition is kept and recorded in the memory unit 12.

(5) In the object detection apparatus 50, the information acquisition unit 112 acquires, as the necessary multiple information, information in which the necessary multiple is defined for every distance from the subject vehicle 101, based on a predetermined size of the stationary object, a scanning angle resolution at which the LiDAR 5 irradiates the laser light or the like, and a predetermined number of measurement points to detect the stationary object.

With such a configuration, it becomes possible to appropriately acquire the necessary multiple information required for the superimposition processing performed by the processing unit 115.

(6) In the object detection apparatus 50, the detection unit 116 further includes the integration unit 117, which detects a moving object, based on the moving point cloud data, and which integrates position information of the stationary object with position information of the moving object.

With such a configuration, it becomes possible to acquire the position information of both the stationary object and the moving object.

The above embodiments can be modified in various manners. Hereinafter, modifications will be described.

### First Modification

In the above description, the detection of the stationary object based on the size of one object OBT (0.3 m in the horizontal direction×0.8 m in the vertical direction) has been described. However, the detection of the stationary object based on the sizes of a plurality of objects OBT1 and OBT2, which are different from each other, may be performed.

Specifically, by setting the size of the first object OBT1 to the above-described size (0.3 m in the horizontal direction×0.8 m in the vertical direction) and the size of the second object OBT2 to, for example, 0.7 m in the horizontal direction×0.15 m in the vertical direction, the stationary object is detected, based on the sizes of these two objects OBT1 and OBT2.

In a case where the objects OBT1 and OBT2 having different sizes are present at equal distances (for example, 100 m) from the subject vehicle 101, the number of measurement points on the object surface increases, as the sizes of the objects OBT1 and OBT2 are larger (in other words, the surface areas are broader), and the number of measurement points on the object surface decreases, as the sizes of the objects OBT1 and OBT2 are smaller.

For this reason, the information acquisition unit 112 acquires two types of necessary multiple information respectively corresponding to the sizes of the two objects OBT1 and OBT2.

The calculation unit 114 calculates the necessary multiples required for respectively detecting the two objects OBT1 and OBT2 for every measurement point that constitutes the stationary point cloud data that has been separated by the separation unit 113, based on the distance from the subject vehicle 101 to each measurement point and the two types of necessary multiple information that have been acquired by the information acquisition unit 112.

Further, in a case where the necessary multiples required for respectively detecting the two objects OBT1 and OBT2 located at the same distance are different from each other, the calculation unit 114 adopts the larger of the necessary multiple values for such a distance.

According to the first modification, it becomes possible to appropriately detect the individual stationary objects respectively, even in a case where there are a small number of measurement points on the surfaces of the plurality of stationary objects OBT1 and OBT2 having different sizes because these plurality of objects OBT1 and OBT2 are stationary in a distant place or the like.

### Second Modification

In a case of using the LiDAR 5 of the time of flight (ToF) method, the speed information indicating the relative moving speed of every measurement point is not included in the point cloud data, unlike a case of the FMCW method. Hence, in a case where the LiDAR 5 adopts the ToF method, the following method may be used as the separation processing of separating the data into the moving point cloud data and the stationary point cloud data in the above-described step S20.

The separation unit 113 projects each measurement point on the XY plane so as to remove information in the height direction from the position information of each measurement point, based on the three-dimensional point cloud data of a plurality of frames that have been consecutively obtained, and converts the position information of each measurement point from three dimensions to two dimensions. That is, each measurement point corresponding to the point cloud data is projected on the XY plane, and the point cloud data is converted into two-dimensional data represented in the XY coordinate system.

Next, offset processing is performed on the position of each measurement point that has been converted into the two-dimensional data, based on the traveling vector of the subject vehicle 101. In other words, the position on the XY plane corresponding to each of the measurement points of the plurality of frames that have been consecutively obtained is offset so as to align the relative coordinate position of the past frame with the above absolute coordinate position, in a case where the relative coordinate position of the most recent frame is set to be the absolute coordinate.

The positions of the measurement points on the XY plane after the offset processing overlap between the most recent frame and the past frame with regard to the measurement point on the stationary object (in other words, the deviation of the positions of the corresponding measurement points is in a state of falling within a predetermined distance between the most recent frame and the past frame), and do not overlap between the most recent frame and the past frame with regard to the measurement point on the moving object.

The separation unit 113 divides the point cloud data of the most recent frame into the moving point cloud data including the measurement points, the positions of which do not overlap the positions of the corresponding measurement points of the past frame, and the stationary point cloud data other than the moving point cloud data, on the XY plane after the offset processing. In this manner, also in a case where the LiDAR 5 adopts the ToF method, simple processing enables separation between the moving point cloud data and the stationary point cloud data.

The above embodiment can be combined as desired with one or more of the above modifications. The modifications can also be combined with one another.

According to the present invention, it becomes possible to appropriately detect a stationary object having a small number of measurement points because it is present in a distant place, for example.

Above, while the present invention has been described with reference to the preferred embodiments thereof, it will be understood, by those skilled in the art, that various changes and modifications may be made thereto without departing from the scope of the appended claims.

What is claimed is:

1. An object detection apparatus comprising:
a detection unit configured to irradiate a three-dimensional space around a moving body with an electromagnetic wave and detect an exterior environment situation around the moving body based on a reflected wave; and
a microprocessor and a memory coupled to the microprocessor, wherein
the microprocessor is configured to perform:
acquiring point cloud data including three-dimensional position information of a measurement point on a surface of an object, from which the reflected wave is obtained, for every frame from the detection unit;
separating the point cloud data into moving point cloud data corresponding to a measurement point on a surface of a moving object and stationary point cloud data other than the moving point cloud data;
calculating, for every measurement point constituting the stationary point cloud data, a necessary multiple required for superimposition processing on data of each measurement point to add the necessary multiple to the data, based on a distance from the moving body to each measurement point;
recording, for every frame, the stationary point cloud data including the data of each measurement point to which the necessary multiple has been added;
extracting a measurement point to be superimposed from the stationary point cloud data of a past frame recorded in the memory, based on the necessary multiple;
performing the superimposition processing to superimpose data of the measurement point to be superimposed on the stationary point cloud data of a new frame, when the stationary point cloud data is separated from the point cloud data of the new frame; and
detecting a stationary object, based on the stationary point cloud data of the new frame after the superimposing processing.

2. The object detection apparatus according to claim 1, wherein
the microprocessor is configured to further perform
acquiring necessary multiple information in which a relationship between the distance from the moving body to the measurement point and the necessary multiple is determined in advance, and
the microprocessor is configured to perform
the calculating including calculating the necessary multiple for each measurement point constituting the stationary point cloud data, based on the distance from the moving body to each measurement point and the necessary multiple information.

3. The object detection apparatus according to claim 2, wherein
the microprocessor is configured to perform
the extracting including extracting the measurement point to be superimposed from measurement points constituting the stationary point cloud data of multiple past frames recorded in the memory, based on which past frame each of the measurement points belongs to relative to a current frame and the distance from the moving body to each of the measurement points.

4. The object detection apparatus according to claim 3, wherein
the microprocessor is configured to perform
the calculating including removing data of measurement points other than the measurement point to be superimposed from the stationary point cloud data of multiple past frames recorded in the memory.

5. The object detection apparatus according to claim 2, wherein
the microprocessor is configured to perform
the acquiring including acquiring, as the necessary multiple information, information in which the necessary multiple is defined for every distance from the moving body, based on a predetermined size of the stationary object, a scanning angle resolution at which the detection unit irradiates the electromagnetic wave, and a predetermined number of measurement points to detect the stationary object.

6. The object detection apparatus according to claim 5, wherein
the stationary object is a first stationary object,
the necessary multiple information is the necessary multiple information corresponding to the first stationary object, and
the microprocessor is configured to perform:
the acquiring including acquiring, the necessary multiple information corresponding to a second stationary object whose size differs from the first stationary object, information in which the necessary multiple corresponding to the second stationary object is defined for every distance from the moving body, based on a predetermined size of the second stationary object, the scanning angular resolution, and a predetermined number of measurement points for detecting the second stationary object; and
the calculating including calculating the necessary multiple for detecting the first stationary object and the necessary multiple for detecting the second stationary object, respectively, for each measurement point constituting the stationary point cloud data, based on the distance from the moving body to each measurement point, the necessary multiple information corresponding to the first stationary object, and the necessary multiple information corresponding to the second stationary object.

7. The object detection apparatus according to claim 6, wherein
the microprocessor is configured to perform
the calculating including calculating, when the necessary multiples for detecting the first stationary object and the second stationary object, which are located at a position equidistant from the moving body, differ from each other, the larger necessary multiple is adopted as the necessary multiple for the position.

8. The object detection apparatus according to claim 1, wherein
the microprocessor is configured to perform
the detecting including detecting a moving object, based on the moving point cloud data, and
integrating position information of the stationary object with position information of the moving object.

9. The object detection apparatus according to claim 1, wherein
the detection unit is LiDAR.
